(19) United States
(12) Patent Application Publication
(10) Pub. No.: US 2026/0346330 A1
(43) Pub. Date: Nov. 5, 2026

(54) Granular Mixture for Additive Manufacturing

(71) Applicant: H. C. STARCK TUNGSTEN GMBH, Goslar (DE)

(72) Inventors: Juliane MEESE-MARKTSCHEFFEL, Goslar (DE); Alexander WOLFF, Holle (DE); Tino SÄUBERLICH, Bad Harzburg (DE); Johannes PÖTSCHKE, Dresden (DE); Christian BERGER, Dohna (DE)

(21) Appl. No.: 19/118,529

(22) PCT Filed: Oct. 27, 2023
(86) PCT No.: PCT/EP2023/080051

§ 371 Date: Apr. 4, 2025

(30) Foreign Application Priority Data
Oct. 28, 2022 (EP) 22204437.2

(51) Int. Cl. B22F 1/105; B22F 1/00; B22F 1/052; B22F 10/10; B33Y 10/00; B33Y 70/00

(52) U.S. Cl. CPC B22F 1/105; B22F 1/052; B22F 1/09; B22F 10/10; B33Y 10/00; B33Y 70/00; B22F 2302/10

(57) ABSTRACT

The present invention relates to a granular mixture for additive manufacturing, its use for producing three-dimensional components by additive manufacturing, and a kit for producing three-dimensional components by additive manufacturing.

The present invention relates to a carbide granular mixture for additive manufacturing, the use thereof for preparing three-dimensional components by additive manufacturing, and a kit for preparing three-dimensional components by additive manufacturing.

As part of the classic production of ceramic and carbide components, green bodies are usually first produced with densities of up to 55% of the theoretical density, which are then dense-sintered under vacuum or a protective atmosphere. The most common shaping process for simple components is uniaxial pressing. Cylindrical components can be manufactured by extrusion, while processes such as powder injection molding can be used for more complex components.

Although this already makes it possible to provide the component with internal structures such as cooling channels, the production of components with more complex geometries using classic processes cannot be achieved at all or can only be achieved with a high degree of rework.

Additive manufacturing processes offer an alternative to traditional manufacturing, in which material is applied layer by layer to create three-dimensional workpieces. Compared to conventional abrasive processes, the layer-by-layer additive structure allows a high degree of flexibility and design freedom, for example in the production of prototypes, but also in series production. The additive manufacturing processes offer the possibility of either producing the component with its full properties directly using the additive structure or first producing a green body, which is then sintered into the desired component in further process steps, similar to classic powder metallurgy processes.

Due to the similarity to existing carbide production processes, binder jetting in particular has become the focus of attention. In binder jetting, a powdery starting material is applied in layers and bonded with a liquid binder at selected locations to create the component. However, binder jetting requires free-flowable powders in order to create an even powder bed.

The prior art offers various approaches to providing free-flowable carbide powders that tend to agglomerate, particularly in the small grain size range, for example by using spheroidized granules.

Thus, for example, US 2016/0375493 describes a method for producing a component in which a sintered carbide powder comprising tungsten carbide and a metallic binder phase is provided, the powder is formed into a green body by one or more additive manufacturing methods, and the green body is sintered to obtain a component with a density of more than 90% of the theoretical density, the green body having a density of less than 50% of the theoretical density before sintering.

U.S. Pat. No. 11,065,863 describes carbide powders for use in additive manufacturing processes that have sintered carbide particles with a density of at least 6 g/cm³ and a bimodal or multimodal granule size distribution.

WO 2015/162206 describes a method for producing a powder from dense and spherically shaped cermet or cemented carbide granules, the method comprising the steps of: (a) producing spherically shaped granules which contain metal, hard components and an organic binder, (b) mixing the spherically shaped granules with a sintering inhibitor powder to form a mixture of spherically shaped granules and the sintering inhibitor powder, (c) loading the mixture of spherically shaped granules and sintering inhibitor powder into an oven chamber, (d) heat-treating the mixture obtained in step (b) in the furnace chamber at a sintering temperature to remove the organic binder from the spherical-shaped granules and to sinter the hard components with the metal in each spherical-shaped granules, thereby forming a mixture of sintered dense spherical-shaped granules and the sintering inhibitor powder, (e) discharging the mixture of sintered, dense, spherically shaped granules and the sintering inhibitor powder from the furnace chamber, and (f) separating the sintering inhibitor powder from the sintered, dense, spherically shaped granules, thereby forming a powder of dense and spherically shaped cermet or cemented carbide granules.

WO 2017/178319 discloses a powder mixture for the three-dimensional printing of a carbide or cermet body, the powder mixture containing 65-85% by weight of porous carbide and/or cermet granules with an average size D50 of 10-35 μm, and 15-35% by weight of dense carbide and/or cermet granules with an average size D50 of 3-10 μm.

WO 2021/072173 describes the production of carbide bodies using powder bed processes, using powders obtained by compacting spherical granules containing tungsten carbide and a metallic binder phase.

US 2020/0346365 describes a powder mixture for use in additive manufacturing methods of components, consisting of sintered carbide particles that have an at least bimodal particle size distribution, with some of the particles having a D50 value of 25 μm to 50 μm and another portion of the particles having a D50 value of less than 10 μm. The bulk density of the powder mixture is 3.5 g/cm³ to 8 g/cm³.

US 2005/126334 describes hybrid carbide composites consisting of a disperse and continuous carbide phase, where the contiguity ratio of the disperse phase is less than or equal to 0.48.

CN 107 557 639 describes a carbide with a three-phase structure, which is characterized in that it is composed of three components with different proportions of a binder phase.

US 2010/044115 describes carbide materials that consist of a disperse and a continuous carbide phase and form a hybrid carbide.

In their article “Vat Photopolymerization of Cemented Carbide Specimen”, issued in Materials 2021, 14, 7631, T. Rieger et al. describe their studies on Vat photopolymerization using photosensitive WC-12 Co (% by weight) slips.

Common granules, such as those obtained by spray drying, usually have a morphology that is too porous to be sufficiently compacted in a subsequent sintering process after additive manufacturing using binder jetting, so that components with a high density are difficult or impossible to access.

There is therefore still a need for carbide granules that can be used in additive manufacturing processes to produce dense components, preferably in binder jetting or comparable processes.

Against this background, it has surprisingly been found in the context of the present invention that this need can be addressed by a granular mixture based on carbides.

Therefore, the present invention firstly relates to a granular mixture for additive manufacturing comprising at least one first granular component A and at least one second granular component B, each of which comprises at least one hard material, wherein at least one of the granular components A or B further comprises at least one binder metal, and wherein the granular components each have a different content of hard material.

For the purposes of the present invention, a “granular component” is understood to mean an agglomerated solid which consists of a large number of primary grains.

The present invention is particularly concerned with the production of three-dimensional components made of carbides. The hard material contained in the granular mixture according to the invention is preferably selected from the group consisting of the carbides of the metals Ta, Ti, Nb, Cr, Hf, V, Mo, Zr and W, and mixtures thereof. More preferably, tungsten carbide (WC) is employed as said hard material.

The granular mixture according to the invention enables the content of the binder metal to be adjusted individually, whereby advantageous sintering behavior is achieved. Therefore, an embodiment is preferred in which both said at least one first granular component A and said at least one second granular component B have a binder metal, the content of binder metal in the granular components being different. Without being bound by theory, it is assumed that due to the different content of hard material and binder metal, an inhomogeneous distribution of the binder metal in the granular mixture is achieved, which can be exploited during sintering to close cavities in the component.

The granular mixture according to the invention is characterized in particular by the different content of hard material in the granular components of the mixture. In a preferred embodiment, the difference in the carbide content between the granular components is at least 1%, preferably at least 5%, more preferably at least 10%.

The binder metal is preferably selected from the group consisting of Cr, Mo, Fe, Co and Ni as well as mixtures and alloys thereof, with Co being particularly preferred as the binder metal.

The ratio of the granular components in the mixture according to the invention can be adjusted as required, in particular with regard to the desired content of binder metal in the granular mixture. A preferred embodiment of the present invention is characterized in that the mass ratio of said at least one first granular component A to said at least one second granular component B is 1:99 to 99:1, preferably 10:90 to 90:10, in particular 1:5 to 5:1.

Preferred embodiments of the present invention include granular mixtures in which only one of the granular components further comprises a binder metal, i.e., one of the granular components only has hard material, as well as granular mixtures in which both granular components have both hard material and binder metal. Thus, an embodiment is preferred in which the content of hard material in said at least one first granular component A is 75 to 95% by mass, preferably 80 to 90% by mass, based in each case on the total mass of the granular component A.

In a further preferred embodiment, the content of hard material in said at least one second granular component B is 90 to 100% by mass, preferably 93 to 97% by mass, based in each case on the total mass of the granular component B.

At least one of the granular components of the granular mixture according to the invention further comprises, in addition to hard material, at least one binder metal. The binder metal content is preferably 5 to 25% by mass, more preferably 10 to 20% by mass, based on the total mass of the granular components.

In a particularly preferred embodiment, the granular mixture according to the invention comprises a first granular component with a hard material content of 75 to 95% by weight, preferably 80 to 90% by weight, and a binder metal content of 5 to 25% by weight, preferably 10 to 20% by weight, and a second granular component with a hard material content of 90 to 100% by weight, preferably 93 to 97% by weight, and a binder metal content of 0 to 10% by mass, preferably 3 to 7% by mass, wherein the mass proportions refer to the total mass of the granular component, with the proviso that the hard material contents of the individual granular components are different. Without being bound to theory, it is assumed that the different contents of hard material and binder metal in the granular components lead to an inhomogeneous distribution of the binder metal in the granular mixture, which leads to movement of the molten metal during sintering, which in turn causes cavities in the component to be closed.

One prior art approach to improving the flowability of carbide powders is to use powders with a bimodal or multimodal grain size distribution. In contrast, within the scope of the present invention, it has been surprisingly found that an advantageous flow and sintering behavior of the powder can also be achieved if the grain size distribution is as homogeneous as possible. Therefore, an embodiment is preferred in which the size distribution of the granular components of the granular mixture according to the invention do not differ from each other by more than 35%, preferably not more than 20%, based on the D50 value of the grain size distribution.

In the context of the present invention, the grain size can be determined, for example, by means of laser diffraction in accordance with DIN ISO 13320:2020. Unless stated otherwise, the grain size distribution as determined by laser diffraction relates to the mass distribution of the granular components. The following applies:

D10: 10% of the mass of the powder has a grain size that is smaller than the specified value, or 90% of the mass of the powder has a grain size that is larger than the specified value.

D50: 50% of the mass of the powder has a grain size that is smaller than the specified value, or 50% of the mass of the powder has a grain size that is larger than the specified value.

D90: 90% of the mass of the powder has a grain size that is smaller than the specified value, or 10% of the mass of the powder has a grain size that is larger than the specified value.

In a preferred embodiment, the granular mixture according to the invention is characterized in that the difference in the D50 values of the hard material particle size distribution in the respective granular components is preferably not more than 20%. The grain size distribution can be determined, for example, using chord length analysis according to ISO 4499-2/3 or EBSD (electron backscatter diffraction) measurement on a scanning electron microscope.

In order to achieve high green densities from the outset, it has proven to be advantageous to use appropriate starting powders. Within the scope of the present invention, it has surprisingly been found that the use of pretreated granular components could achieve a further improvement of green density. Granular components with a low porosity, as can be obtained by thermal compression of spray-dried granules, have proven to be particularly advantageous. Therefore, an embodiment is preferred in which the granular components of the granular mixture according to the invention are spray-dried, thermally compacted granules. Thermal compression is preferably carried out using sintering, microwave or plasma treatment.

In a preferred embodiment, the granular components of the granular mixture according to the invention are obtained by spray drying, thermal compression and subsequent fractionation, wherein the fractionation is preferably carried out in such a way that granular components with a grain size distribution D50 of 10 to 35 μm, preferably 15 to 25 μm, and/or with a grain size distribution D90 of 25 to 50 μm, preferably ≤50 μm, are obtained.

More preferably, granular components are used which have a porosity of 0 to 40% by volume, preferably 20 to 35% by volume, in which the porosity can be determined, for example, by means of gas adsorption measurements in accordance with DIN ISO 9277:2014.

The granular components used in the granular mixture according to the invention preferably have a BET surface area of 0.01 to 1 m²/g, more preferably 0.1 to 0.5 m²/g.

Further preferred is an embodiment in which the granular mixture has a bulk density of 30 to 50% of the theoretical density, determined according to ASTM B329, wherein the theoretical density can be found in corresponding tables. Preferably, the granular mixture has a tap density of at least 35%, preferably more than 40%, more preferably more than 46%, of the theoretical density as determined according to ASTM B527. Within the scope of the present invention, it has been found that granular components having such a property profile can be used to prepare components with high densities.

“Granules” usually designates a macroscopic particle that is made up of many small primary particles, also known as grains. The primary particles are held together by adhesive forces, such as those created by sinter bridges. These adhesive forces can be broken down again, and a certain granule strength has proven to be advantageous when using such granules, as this strength can have a positive effect on the properties of the later component. Therefore, an embodiment of the present invention is preferred in which the grains of the granular component according to the invention have a compressive strength of more than 400 MPa. Such strength of the granules can be determined by a compression test, for example.

Depending on requirements, further components can be added to the granular mixture according to the invention, with particular preference being given to further components which are carbides of the metals of the 4th to 6th groups of the periodic table. The other components can be granulated or powdered. The other components can be used, for example, to advantageously influence the sintering behavior of the granular mixture according to the invention.

The granular mixture according to the invention was developed in particular for use in additive manufacturing techniques. Therefore, the present invention further relates to the use of a granular mixture according to the invention for the production of three-dimensional components using additive manufacturing techniques, preferably using binder jetting or powder bed fusion. Surprisingly, it has been found that the use according to the invention leads to components with a high density.

The present invention further relates to a process for producing a three-dimensional component using the granular mixture according to the invention. The process includes the following steps:
a) providing a granular mixture according to the present invention;
b) printing out said granular mixture to form a three-dimensional green body; and
c) sintering the green body to obtain the three-dimensional component.

Said printing out is preferably performed by binder jetting.

Within the scope of the process according to the invention, the granular mixture according to the invention can be printed out together with a binder. Therefore, the process preferably comprises a step of removing the binder from the green body prior to sintering.

The present invention further relates to a kit for preparing a three-dimensional component by additive manufacturing, including at least one first granular component A and at least one second granular component B, each of which comprises at least one hard material, wherein at least one of the granular components A or B further comprises at least one binder metal, and wherein the granular components each have a different content of hard material.

The present invention is described in more detail by means of the following Examples and Figures, which should by no means, however, be understood as limiting the idea of the invention.

### EXAMPLES

A spray-dried WC/Co powder was sintered at 1000 to 1200 °C and then sifted and sieved so that a D50 of the granule size distribution of 20 μm was achieved. In this way, two granular components A and B were produced and processed into a granular mixture according to the invention. The composition is shown in Table 1:

| | WC [% by mass] | Co [% by mass] |
|---|---|---|
| Granular component A | 95 | 5 |
| Granular component B | 85 | 15 |
| Granular mixture | 90 | 10 |

The granular mixture was printed out by binder jetting into a test specimen, freed from binder, and sintered. The thus prepared test specimen had a density of more than 99% of its theoretical density.

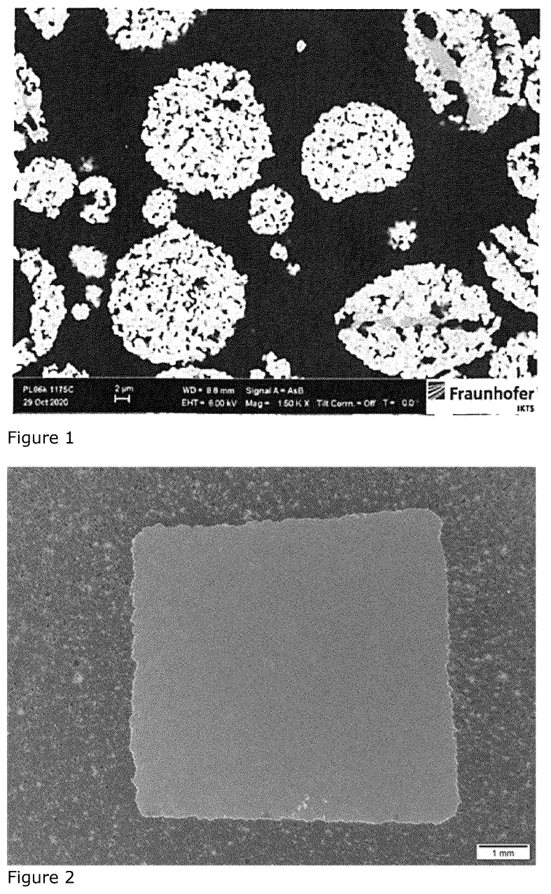

FIG. 1 shows a scanning electron micrograph of a WC/Co granular mixture according to the invention with an inhomogeneous distribution of the binder metal (dark grey).

FIG. 2 shows the cut of a test specimen prepared by sintering or with an additive process with the granular mixture according to the invention. The high density of the test specimen is clearly seen.

1. A granular mixture for the additive manufacturing of carbide components, including at least one first granular component A and at least one second granular component B, each of which comprises at least one hard material, wherein at least one of the granular components A or B further comprises at least one binder metal, and wherein the granular components each have a different content of hard material.

2. The granular mixture according to claim 1, characterized in that the hard material contained in the granular mixture is selected from the group consisting of the carbides of the metals Ta, Ti, Nb, Cr, Hf, V, Mo, Zr and W, and mixtures thereof.

3. The granular mixture according to claim 1, characterized in that said at least one first granular component A and said at least one second granular component B have a binder metal, the content of binder metal in the granular components being different.

4. The granular mixture according to claim 1, characterized in that said binder metal is selected from the group consisting of Cr, Mo, Fe, Co and Ni, and mixtures and alloys thereof.

5. The granular mixture according to claim 1, characterized in that the content of hard material in said at least one first granular component A is 75 to 95% by mass, based in each case on the total mass of the granular component A.

6. The granular mixture according to claim 1, characterized in that the content of hard material in said at least one second granular component B is 90 to 100% by mass, based in each case on the total mass of the granular component B.

7. The granular mixture according to claim 1, characterized in that the size distributions of the granular components do not differ from each other by more than 35%, based on the D50 value of the grain size distributions as determined according to DIN ISO 13320:2020.

8. The granular mixture according to claim 1, characterized in that the granular components are spray-dried, thermally compacted granules.

9. The granular mixture according to claim 1, characterized in that the granular components have a porosity of 0 to 40% by volume.

10. The granular mixture according to claim 1, characterized in that the granular components have a BET specific surface of 0.01 to 1 m²/g, as determined according to DIN ISO 9277:2014.

11. The granular mixture according to claim 1, characterized in that the granular mixture has a bulk density of 30 to 50% of the theoretical density, determined according to ASTM B329.

12. The granular mixture according to claim 1, characterized in that the granular mixture has a tap density of at least 35% of the theoretical density as determined according to ASTM B527.

13. (canceled)

14. A process for producing a three-dimensional component, comprising the following steps:
a) providing a granular mixture according to claim 1;
b) printing out said granular mixture to form a three-dimensional green body; and
c) sintering the green body to obtain the three-dimensional component.

15. A kit for preparing a three-dimensional component by additive manufacturing methods, including at least one first granular component A and at least one second granular component B, each of which comprises at least one hard material, wherein at least one of the granular components A or B further comprises at least one binder metal, and wherein the granular components each have a different content of hard material.

16. The granular mixture according to claim 1, characterized in that the content of hard material in said at least one first granular component A is 80 to 90% by mass, based in each case on the total mass of the granular component A.

17. The granular mixture according to claim 1, characterized in that the content of hard material in said at least one second granular component B is 93 to 97% by mass, based in each case on the total mass of the granular component B.

18. The granular mixture according to claim 1, characterized in that the size distributions of the granular components do not differ from each other by more than 20%, based on the D50 value of the grain size distributions as determined according to DIN ISO 13320:2020.

19. The granular mixture according to claim 1, characterized in that the granular components have a porosity of 20 to 35% by volume.

20. The granular mixture according to claim 1, characterized in that the granular components have a BET specific surface of 0.1 to 0.5 m²/g, as determined according to DIN ISO 9277:2014.

21. The granular mixture according to claim 1, characterized in that the granular mixture has a tap density of more than 40% of the theoretical density as determined according to ASTM B527.
